(19) United States
(12) Patent Application Publication
(10) Pub. No.: US 2023/0249294 A1
(43) Pub. Date: Aug. 10, 2023

(54) SACFRIFICIAL LAYER TO FACILITATE WELDING OF THIN FOILS

(71) Applicant: GM Global Technology Operations LLC, Detroit, MI (US)

(72) Inventors: Teresa Jean Rinker, Royal Oak, MI (US); Liang Xi, Northville, MI (US); Xun Liu, Columbus, OH (US); Ho Kwon, Hilliard, OH (US); Umair H. Shah, Dublin, OH (US)

(21) Appl. No.: 17/668,708

(22) Filed: Feb. 10, 2022

(51) Int. Cl. B23K 35/02; H01M 50/536

(52) U.S. Cl. CPC B23K 35/0261; H01M 50/536; B23K 2101/36

(57) ABSTRACT

A non-stick electrode comprises an electrode an electrically insulating sheath disposed thereon. The electrically insulating sheath has an opening on a surface of the electrode through which an electrical current is transmitted or received to or from an opposing electrode respectively. The electrode protrudes through the opening in the insulating sheath. An electrically conducting interlayer is disposed on the electrode such that it contacts the electrode at the opening in the electrically insulating sheath. The electrically conducting interlayer comprises a material that decomposes at a temperature that is greater than a temperature of a metal that is liquified on contact with the non-stick electrode.

### INTRODUCTION

This disclosure relates to a sacrificial layer to facilitate the welding of multiple thin foils.

Resistance spot welding is often used to weld together a plurality of battery foils. This welding process is used primarily for welding two or more metal sheets together by applying pressure and heat from an electric current to the weld area. The electric current is applied to the weld area via an electrode.

FIG. 1 depicts a conventional resistance spot welding operation where a plurality of battery foils 202 and 204 are welded together using an electric current. Electrodes 102 and 104 are in electrical communication with the battery foils 202 and 204 to heat them and to create a molten puddle 206 in each plurality of battery foils 202 and 204. The puddle upon solidifying bonds the plurality of foils together. As may be seen in the FIG. 1, the top and the bottom puddles each have a semi-elliptical shape. The puddles when combined have an elliptical shape.

However, this method of welding the plurality of battery foils (which comprise aluminum or copper) is often challenging. One of these challenges includes the penetration of the molten puddle through the foils and the subsequent bonding 208 of the foils with the electrode (which comprises a Cu alloy) thus damaging the electrode. This renders the electrode unsuitable for the next welding operation.

This undesirable bonding significantly deteriorates the electrode service life, increases electrode cost and slows down the production rate, which renders the process unacceptable for welding multiple thin films of aluminum and copper.

### SUMMARY

A non-stick electrode comprises an electrode an electrically insulating sheath disposed thereon. The electrically insulating sheath has an opening on a surface of the electrode through which an electrical current is transmitted or received to or from an opposing electrode respectively. The electrode protrudes through the opening in the insulating sheath. An electrically conducting interlayer is disposed on the electrode such that it contacts the electrode at the opening in the electrically insulating sheath. The electrically conducting interlayer comprises a material that decomposes at a temperature that is greater than a temperature of a metal that is liquified on contact with the non-stick electrode.

In an embodiment, the electrode comprises a metal. The metal is copper, a copper-tungsten alloy, copper alloys, steel, brass, tungsten, chromium, zirconium, molybdenum, or a combination thereof.

In another embodiment, the electrically insulating sheath comprises a ceramic or an organic polymer.

In yet another embodiment, the ceramic comprises silica, quartz, alumina, titania, ceria, zirconia, boron nitride, or a combination thereof.

In yet another embodiment, the electrically conducting interlayer comprises graphene, graphite, carbon-nanotube paper; carbon nanotube-carbon black paper; or a combination thereof.

In yet another embodiment, the electrically conducting interlayer is replaceable.

In yet another embodiment, the electrically conducting interlayer prevents adhesion of the electrode to a battery foil or to a battery tab during a resistance welding operation.

In yet another embodiment, the electrically insulating sheath has a thickness of 50 to 300 micrometers.

In yet another embodiment, the opening on the surface of the electrode has a diameter of 2 to 10 millimeters.

In yet another embodiment, the electrically conducting interlayer has a thickness of 0.1 to 0.5 millimeters.

In yet another embodiment, the electrically conducting interlayer is reversibly bonded to the electrically insulating sheath with boron nitride.

In an embodiment, a spot welding device comprises the non-stick electrode.

In an embodiment, the spot welding device comprises an opposing electrode that lies opposite to the non-stick electrode. The opposing electrode is also a non-stick electrode that comprises the electrically conducting interlayer.

In an embodiment, the spot welding device comprises an opposing electrode that lies opposite to the non-stick electrode. The opposing electrode is not a non-stick electrode.

In an embodiment, the spot welding device comprises an opposing electrode that contacts a graphite foil and wherein an opposite side of the graphite foil contacts a battery foil or tab.

A method of manufacturing a non-stick electrode comprises disposing an electrically insulating sheath on an electrode. The electrically insulating sheath has an opening on a surface of the electrode through which an electric current is transmitted or received to or from an opposing electrode respectively. The electrode protrudes through the opening in the insulating sheath. An electrically conducting interlayer is disposed on the electrode such that it contacts the electrode at the opening in the insulating sheath. The electrically conducting interlayer comprises a material that decomposes at a temperature that is greater than a temperature of a metal that is liquified on contact with the non-stick electrode.

In an embodiment, the electrically conducting interlayer contacts the electrically insulating sheath.

A method of performing a spot weld comprises disposing a battery tab and a plurality of battery foils between two opposing electrodes. At least one of the electrodes is a non-stick electrode. The non-stick electrode comprises an electrode and an electrically insulating sheath disposed thereon. The electrically insulating sheath has an opening on a surface of the electrode through which current is transmitted or received to or from an opposing electrode respectively. An electrically conducting interlayer is disposed on the electrode such that it contacts the electrode at the opening in the electrically insulating sheath. The electrically conducting interlayer comprises a material that decomposes at a temperature that is greater than a temperature of a metal that is liquified on contact with the non-stick electrode. An electrical current is discharged between the two opposing electrodes to melt a portion of the battery foils. The molten portion of the battery foils are then solidified thus bonding them together.

In an embodiment, the battery tab is bonded to the battery foils when the molten portion of the battery foils undergoes solidification.

In an embodiment, the electrical current is discharged to the non-stick electrode from the opposing electrode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a depiction of a prior art method of using resistance spot welding to bond together a plurality of battery foils;

FIG. 2A is an exemplary schematic sectional depiction of the electrode with the electrically conducting interlayer disposed thereon;

FIG. 2B is a top view of the upper surface of the non-stick electrode prior to the positioning of the electrically conducting interlayer on the upper surface of the electrically insulating sheath;

FIG. 3A is a schematic depiction of an exemplary resistance spot welding device that comprises non-stick electrodes;

FIG. 3B is a schematic depiction of another exemplary resistance spot welding device that comprises non-stick electrodes;

FIG. 4A is a schematic depiction of another exemplary resistance spot welding device that comprises one non-stick electrode. The opposing non-stick surface is a graphite interlayer;

FIG. 4B is a schematic depiction of another exemplary resistance spot welding device that comprises one non-stick electrode. The opposing non-stick surface is a graphite interlayer;

FIG. 5A is a schematic depiction of another exemplary resistance spot welding device that comprises two opposing graphite interlayers;

FIG. 5B is another schematic depiction of another exemplary resistance spot welding device that comprises two opposing graphite interlayers;

FIG. 6 is a depiction of a device that comprises one non-stick electrode and an opposing knurled electrode;

FIG. 7 is a depiction of the protrusions that form the individual knurls;

FIG. 8 is a depiction of an inclined non-stick electrode; and

FIG. 9 depicts an exemplary method of welding the battery foils.

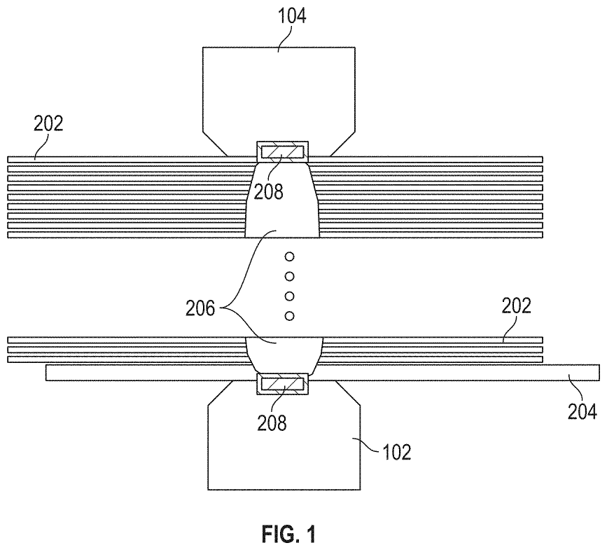

### DETAILED DESCRIPTION

The following description is merely exemplary in nature and is not intended to limit the present disclosure, its application or uses. It should be understood that throughout the drawings, corresponding reference numerals indicate like or corresponding parts and features.

Disclosed herein is a device for resistance spot welding a plurality of battery foils to each other. The foils may also be welded to a battery tab. This resistance spot welding is conducted without any damage to the electrodes (that are used for transmitting the electrical current to facilitate the welding) and without any bonding between the electrodes and the plurality of battery foils. The device comprises one or more electrodes that have an electrically conducting interlayer disposed on a surface of the electrode that contacts the plurality of battery foils. These electrodes having the electrically conducting interlayer are called non-stick electrodes. The electrically conducting interlayer may act as a sacrificial layer that may decompose at a higher temperature than the melting point of the battery foils. It therefore prevents the puddle produced as a result of the melting of the foils from contacting the electrode and damaging the electrode. The presence of an electrically conducting interlayer between the non-stick electrode and the battery tab/foils provides the electrode with a longer life cycle and prevents damage to the battery foils as well.

It is to be noted that the electrically conducting interlayer may be reversibly bonded to the electrode or alternatively placed between an electrode surface and the foils (without being bonded to the electrode). The electrically conducting interlayer is replaceable and can be removed from the electrode and replaced with a new interlayer when desired.

The method comprises transmitting an electrical current from the non-stick electrode to a plurality of battery foils through the electrically conducting interlayer. The electrical current promotes resistive heating and melting of a portion of the battery foils to produce a molten puddle. The foils are then bonded together (when the molten puddle solidifies). The presence of the interlayer prevents bonding of the battery foils or the battery tab to the non-stick electrode.

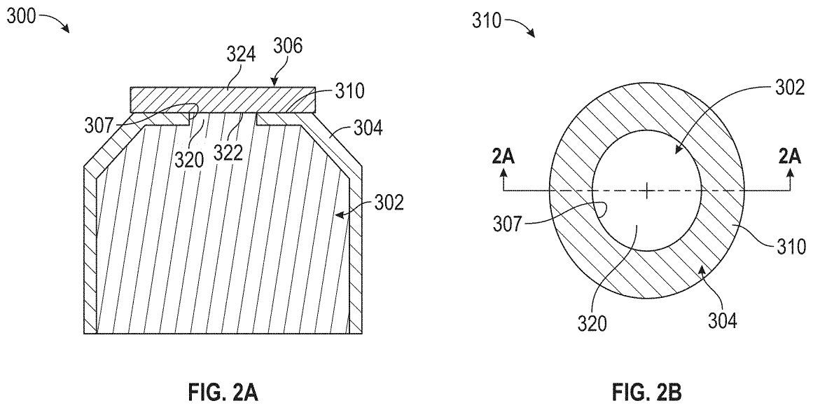

FIG. 2A is an exemplary schematic depiction of a non-stick electrode 300 with the electrically conducting interlayer 306 disposed thereon. FIG. 2A is a sectional side view the non-stick electrode 300. The non-stick electrode 300 comprises an electrode 302 (preferably having a cylindrical shape) that comprises an electrically conducting metal. The electrode 302 has a protrusion 320 that protrudes through an electrically insulating coating 304 to contact the electrically conducting interlayer 306. The electrically insulating coating 304 is also referred to as an electrically insulating sheath 304 because it protects the electrode. While the electrode 302 preferably has a circular cross-sectional area, the cross-sectional area may have any other desirable geometry such as, for example, square, rectangular, polygonal, or the like, or a combination thereof. The electrically conducting metal may comprise copper, steel, brass, tungsten, chromium, zirconium, molybdenum, copper alloys such as copper-tungsten; or the like, or a combination thereof. An exemplary electrically conducting metal for the electrode is copper.

The electrically insulating sheath 304 covers a portion of the electrode 302. The upper portion of the electrically insulating sheath 304 contacts the electrically conducting interlayer 306 at the upper surface 310 of the electrically insulating sheath 304. An opening 307 in the electrically insulating sheath 304 permits the electrode 302 to protrude (the protrusion 320) through and contact the electrically conducting interlayer 306 at its first surface 322. The protrusion 320 is not covered by the electrically insulating sheath 304. The second surface 324 of the electrically conducting interlayer 306 (that is opposed to the first surface 322) that does not contact the electrode 302 contacts a plurality of battery foils (not shown) to melt the foils during operation. In other words, a first surface 322 of electrically conducting interlayer 306 contacts an upper surface 310 of the electrically insulating sheath 304 and the protrusion 320 (at the upper surface of the electrode 302). The contact between the first surface 322 of the electrically conducting interlayer 306 and the protrusion 320 permits an electrical current to be transmitted from the electrode to battery foils (not shown) to melt a portion of the battery foils and weld them together when the melt solidifies.

FIG. 2B is a top view of the upper surface 310 of the non-stick electrode 300 prior to the positioning of the electrically conducting interlayer 306 on the upper surface of the electrically insulating sheath 304. The electrical insulating sheath 304 is disposed on the entire electrode 302 except for the protrusion 320 which is uncoated. The electric insulating sheath 304 covers all vertical surfaces of the electrode 302 leaving only an uncoated circular region on the horizontal surface 310 through which the electrode 302 protrudes (i.e., the protrusion 320) and through which an electrical current can be transmitted to the battery foils/tab through the electrically conducting interlayer 306 (See FIG. 2A.) The electrically conducting interlayer 306 is then disposed on the electrode 302 to contact the upper surface 310 of the electrically insulating sheath 304. The electrode 302 with the electrically conducting interlayer 306 disposed on the upper surface 310 of the electrically insulating sheath 304 is termed the non-stick electrode 300.

In an embodiment, the electrically conducting interlayer 306 may be bonded to the upper surface of the electrode 302 via an electrically insulating coating such as boron nitride (not shown). The insulating coating prevents short-circuiting at the electrode 302 corners, and also prevents displacement of the electrically conducting interlayer 306 from the electrode 302 during a resistance spot welding operation.

The electrical insulation (for the electrically insulating sheath 304) can comprise a ceramic or in some instances an organic polymer. Suitable ceramics are silica, quartz, alumina, titania, boron nitride, ceria, or the like, or a combination thereof. Suitable organic polymers are those that can withstand the temperature of the welding operation. In an embodiment, the polymers that are used in the electrically insulating sheath 304 have glass transition temperatures of greater than 200° C. The polymers can be thermoplastic polymers, thermosetting polymers, or a combination thereof. Examples of organic polymers are polyimides, polyetherimides, polyether ether ketone, polybenzoxazoles, polysiloxanes, polytetrafluoroethylene, polysulfones, polyethersulfones, or the like, or a combination thereof.

The electrically insulating sheath 304 has a uniform thickness of 50 to 300 micrometers, preferably 100 to 200 micrometers. The protrusion 320 in the electrically insulating sheath 304 can have a circular, square, or a polygonal cross-sectional area. In an embodiment, the protrusion 320 has a circular cross-sectional area having a diameter of 2 to 10 millimeters.

The electrically conducting interlayer 306 may comprise an electrically conducting material that is preferably inert and does not melt at the temperature at which the welding takes place. It preferably decomposes or melts at a much higher temperature when compared with the melt temperature of the battery foils. It also does not react with or bond to the electrodes of the resistance spot welding device. In another embodiment, the material used in the electrically conducting interlayer 306 does not undergo solubilization with materials used in the electrode or in the foils (e.g., elements such as copper and aluminum) when they are in the melt.

The electrically conducting interlayer 306 also preferably has a higher electrical resistivity than the material used in the electrode as well as the material used in the battery foils. Since the electrode generally comprises copper and the battery foils may comprise either aluminum or copper, it is desirable for the electrically conducting interlayer to have a higher electrical resistivity that either copper or aluminum. The higher electrical resistivity of the electrically conducting interlayer 306 facilitates a change in the geometry (shape) of the molten puddle in the plurality of foils when they are subjected to resistive heating.

The electrically conducting interlayer 306 comprises graphene sheets, graphene oxide sheets, carbon nanotube paper, a compressed layer of aligned carbon nanotubes, or the like, or a combination thereof.

In one embodiment, the graphene sheets include one or more layers of graphene having a d-spacing of 0.33 to 0.358 nm. The graphene sheets can contain crystals that are uniformly oriented or may even be randomly oriented but preferably form a solid, non-porous film. While it is desirable for the electrically conducting interlayer to be non-porous, it can include pores so long as the pores are not large enough to permit the molten puddle resulting from the melting of the foils to penetrate the interlayer. In another embodiment, the electrically conducting interlayer can include pores so long as the pores do not provide a direct passage (e.g., a percolating pathway) for the molten metal to travel from a surface that contacts the electrode to the surface that contacts the battery foils.

In another embodiment, the electrically conducting interlayer includes one or more layers of graphene having a d-spacing of 0.33 to 0.358 nm. The graphene layers can contain crystals that are uniformly oriented or may even be randomly oriented but preferably form a solid, non-porous film.

In another embodiment, the electrically conducting interlayer includes one or more layers of electrically conducting graphene oxide having a d-spacing of 0.8 to 0.9 nm. The graphene oxide may contain oxygen atoms in an amount that facilitates retention of its electrical conductivity. This permits an electrical current to be transmitted from the electrode to the foils to facilitate welding. The graphene oxide layers can contain crystals that are uniformly oriented or may even be randomly oriented but preferably form a solid, non-porous film. The graphene oxide layers can be porous so long as they do not permit molten metal to be transported from one surface of the interlayer to another.

In yet another embodiment, the electrically conducting interlayer can include a paper sheet that comprises carbon nanotubes. Carbon nanotubes can be sonicated in an ultrasound sonicator to break up aggregates and agglomerates. The carbon nanotubes thus dispersed may then be poured or spun coated onto a substrate to form the paper sheet. The paper sheet may be porous or non-porous depending upon thickness of the sheet. The sheet is electrically conducting and can serve as an interlayer to facilitate transmission of the electrical current from the electrode to the battery foils.

In an embodiment, the nanotube sheet can contain carbon black (or another electrically conducting filler that has a higher decomposition temperature than the melting temperature of the foils) dispersed in the interstices of the carbon nanotubes. The paper sheet containing carbon nanotubes along with the carbon black can be manufactured in a manner similar to those containing only carbon nanotubes (detailed above).

In yet another embodiment, the electrically conducting interlayer may comprise a layer of compressed aligned carbon nanotubes that are in the form of a sheet. Vertically or horizontally aligned carbon nanotubes may be grown in a manufacturing chamber. The aligned carbon nanotubes may be compressed to establish uniform electrical contact and conductivity throughout the interlayer. Compressing the aligned carbon nanotube layer also provides the interlayer with strength to withstand operational handling during manufacturing.

In another embodiment, the electrically conducting interlayer comprises graphite. Graphite in the form of flakes may be pressed into a uniformly thick layer (e.g., a graphite foil) and used as the electrically conducting interlayer.

The electrically conducting interlayer has a thickness that is dependent upon the average total thickness of the plurality of battery foils and the battery lead (also sometimes called the battery tab). An exemplary thickness of the electrically conducting interlayer is 0.1 to 0.5 millimeters, preferably 0.15 to 0.3 millimeters.

The non-stick electrode with the electrically conducting interlayer and the electrically insulating sheath disposed thereon can be used in a resistance spot welding operation as detailed below.

The use of the electrically conducting interlayer in conjunction with the electrodes can be deployed in a plurality of different configurations to bond the battery foils with substantially reduced or no damage to the electrodes. In one configuration, both of the opposing electrodes of the device are fitted with an electrically conducting interlayer that is bonded to the electrode by an electrically insulating adhesive such as boron nitride. In another configuration, only one of the electrodes is a non-stick electrode that comprises the electrically conducting interlayer, while the opposing electrode is not a non-stick electrode but instead contacts a battery tab (or battery foils) directly or alternatively, contacts the battery tab (or battery foils) through a non-stick layer (such as a graphite layer) which is not bonded to the electrode. These are detailed below.

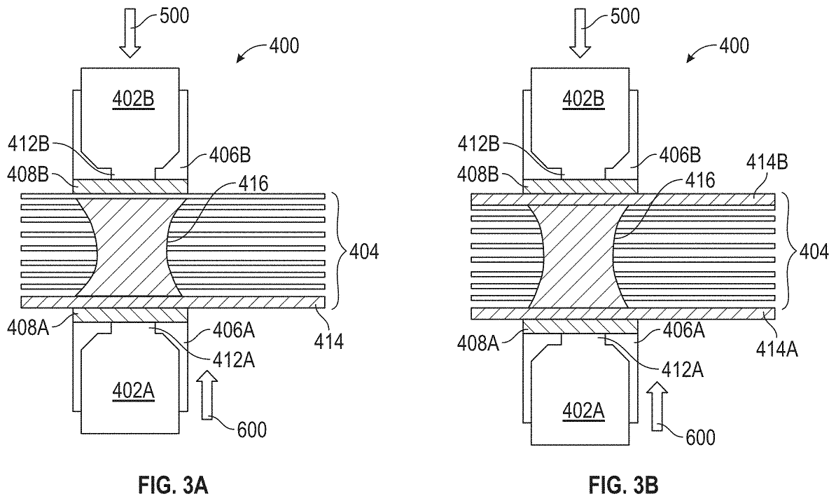

FIG. 3A depicts a spot welding device 400 that comprises electrodes (first electrode 402A and second electrode 402B) that are used to spot weld a plurality of (battery) foils 404 with a single battery lead (also called a tab) 414. In the FIG. 3B, the plurality of foils 404 are contacted by two battery leads 414A and 414B.

In the FIGS. 3A and 3B both opposing electrodes 402A and 402B are fitted with electrically conducting interlayers 408A and 408B respectively. In other words, both electrodes 402A and 402B are non-stick electrodes. The first and second electrodes 402A and 402B respectively are also coated with the electrical insulation sheath 406A and 406B respectively leaving uncoated protrusions 412A and 412B for an electrical current to travel.

In the FIG. 3A when it is desirable to spot weld the battery foils 404, the first electrode 402A contacts the plurality of foils 404 while the second electrode 402B contacts the tab 414 (which is electrical communication with the foils 404). A welding force (pressure) 500 is applied to the opposing electrodes and an electrical current is applied from the first electrode 402A to the second electrode 402B. An ultrasonic assisted vibration 600 provides mechanical vibration to the workpiece through the electrode which is applied at the onset of welding until the end of the last resistance pulse. The ultrasonic assisted vibration facilitates the formation of a molten puddle 416. This electric current produces heating and melting of the foils producing a puddle 416 that has an hour glass shape. The puddle, on solidifying, bonds the foils together and bonds the foils to the battery lead 414. The presence of the electrically conducting interlayer minimizes damage to the electrodes 402A and 402B.

In the FIG. 3B, the electrically conducting interlayers 408A and 408B contact the first tab 414A and the second tab 414B respectively. As noted above in the FIG. 3A, a welding force (pressure) 500 is applied to the opposing electrodes and an electrical current is applied from the first electrode 402A to the second electrode 402B. This electric current produces heating and melts of the foils to produce an hour glass shaped puddle 416. The puddle on solidifying bonds the foils 404 together and bonds the foils to the leads 414A and 414B. The presence of the electrically conducting interlayer minimizes damage to the electrodes.

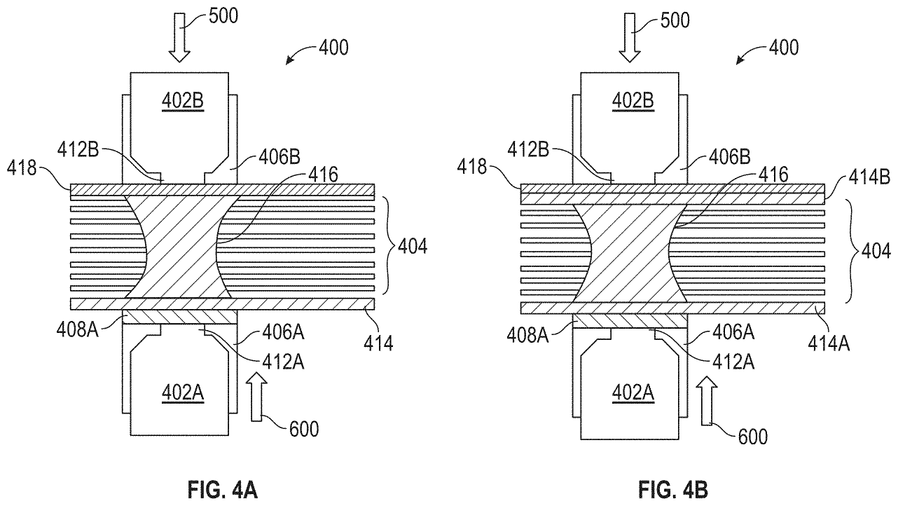

In another embodiment depicted in the FIGS. 4A and 4B only one of the opposing electrodes (the first electrode 402A) comprises a non-sticking electrode 408A, while the other electrode (the second electrode 402B) is not a non-sticking electrode and contacts the battery foils through a graphite foil 418.

FIG. 4A depicts one embodiment where the spot welding device 400 comprises two opposing electrodes—a first electrode 402A fitted with the electrically conducting interlayer 408A and a second electrode 402B that does not contain an electrically conducting interlayer. The other parts of the device of the FIG. 4A are similar to those depicted in the FIG. 3A and hence will not be elaborated upon again in the interests of brevity. As may be seen in the FIG. 4A the electrically conducting interlayer 408A contacts the tab 414.

FIG. 4B depicts another embodiment of the resistance spot welding device 400 where the first electrode 402A is fitted with the electrically conducting interlayer 408A and contacts a first tab 414A, while the opposing second electrode 402B does not contain the electrically conducting interlayer and contacts a second tab 414B through a graphite foil 418. The other parts of the device of the FIG. 4A are similar to those depicted in the FIG. 3A and hence will not be elaborated upon again in the interests of brevity. As noted above in the FIG. 4A, a welding force (pressure) 500 is applied to the opposing electrodes of the device of the FIG. 4B and an electrical current is applied from the first electrode 402A to the second electrode 402B. This electric current produces heating and melts of the foils to produce an hour-glass shaped puddle 416. The puddle, on solidifying, bonds the foils 404 together and bonds the foils to the lead 414. The presence of the electrically conducting interlayer 408A minimizes damage to the electrode 402A.

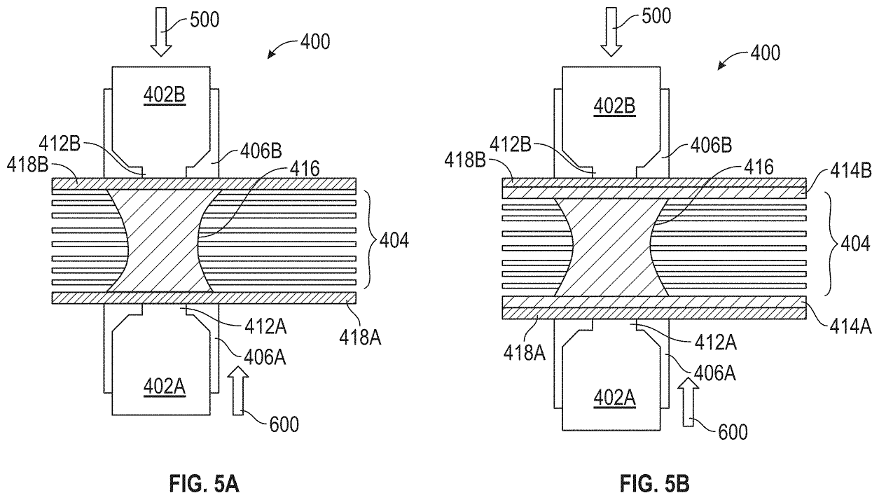

FIG. 5A and 5B depicts embodiments where neither of the opposing electrodes is a non-stick electrode. In the FIG. 5A, the first electrode 402A contacts the battery foils 404 through a first graphite foil 418A while the second electrode 402B contacts the battery foils 404 through a second graphite foil 418B. The graphite foils 418A or 418B have a thickness of 0.1 to 0.5 millimeters, preferably 0.2 to 0.4 millimeters. In the FIG. 5B, the first electrode 402A contacts the battery foils 404 through a first graphite foil 418A and a first tab 414A while the second electrode 402B contacts the battery foils 404 through a second graphite foil 418B and a second tab 414B. The device functions as detailed in the description related to FIG. 4A and will not be repeated here again.

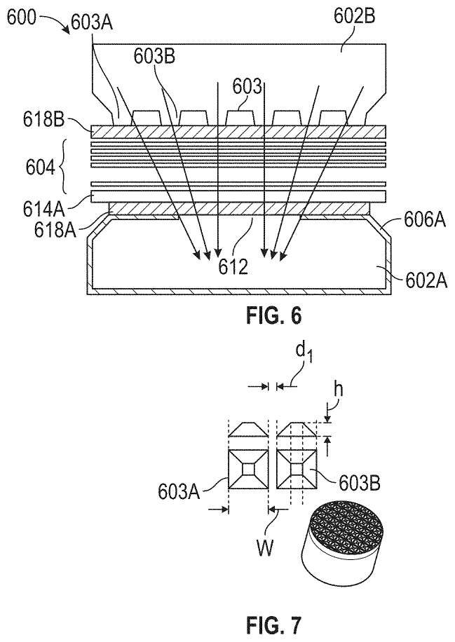

FIG. 6 depicts a resistance spot welding device 600 where one or more of the electrodes have knurled surfaces. The device 600 comprises opposing electrodes—first electrode 602A and second electrode 602B that are disposed on opposing sides of the battery foils 604 during the welding process. The first electrode 602A is a non-sticking electrode that has an electrically insulating sheath 606A disposed thereon. An electrically conducting interlayer 618A is disposed on the upper surface of the electrode

As previously detailed, the electrically insulating sheath 606A accommodates protrusion 612 through which an electrical current can be transmitted or received. The protrusion 612 is such that the upper surface of the electrode 602A is exposed to the electrically conducting interface 618A. The electrically conducting interface 618A is bonded to the upper surface of the electrically insulating sheath 606A (of the non-stick electrode 602A). In the instant case, the electrically conducting interface 618A is a graphene layer.

The electrically conducting interface 618A is in electrical communication with the tab 614A and the plurality of foils 604 through the tab 614A.

The second electrode 602B (that opposes the first electrode 602A) has a knurled surface 603 that comprises a plurality of protrusions 603A, 603B, and so on. FIG. 7 depicts one exemplary type of protrusion (e.g., 603A, 603B) that may be used on a knurled surface. These knurls have a truncated pyramid geometry and have a height “h” that ranges from 0.2 to 0.6 millimeters, a width w that ranges from 1 to 3 millimeters and a spacing d₁ that ranges from 0.1 to 0.4 millimeters. In an embodiment, the height h, the width w and the spacing d₁ depends on the total thickness of the battery foils stack. If the total battery foil thickness is t, the height h varies from 0.5 t to 0.6 t, width w varies from 1 h to 1.2 h and the spacing d₁ varies from 0.3 h to 0.6 h.

While the knurls in the FIG. 7 can be shown to be uniform, they can be non-uniform of varying height and width. They can be periodic or aperiodic. The cross-sectional area of each protrusion that forms the knurls may be square, rectangular, circular, triangular or polygonal. They may also be irregular.

The second electrode 602B is not a non-sticking electrode. It is however, in electrical communication with the plurality of battery foils 604 via a graphite layer 618B. The presence of a knurled surface 603 concentrates the electrical current applied across the battery foils 604 (from the electrode 602B to the electrode 602A) at the points of contact between the knurled surface and the graphite interlayer 618B. This concentrated current leads to the creation of multiple puddles of molten metal, which then expand and fuse together to form one wide molten puddle. The foils are bonded upon solidification of the wide molten puddle, which produces a large bonding area.

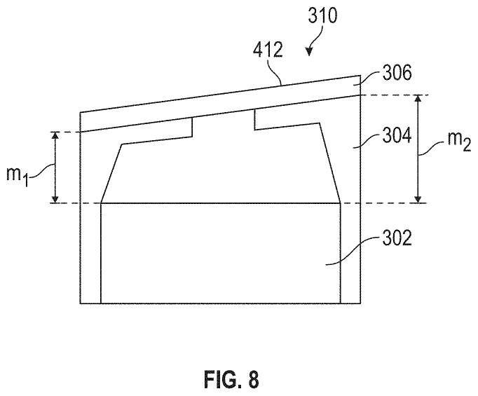

From the FIGS. 4A through 6, it may be seen that the surface of the electrodes that contact the tab or the battery foils may be planar or knurled. The surface may also be inclined as depicted in the FIG. 8.

FIG. 8 depicts a non-stick electrode 310 that has an inclined surface 412 that contacts the battery foils (not shown). The non-stick electrode 310 comprises an electrode 302 with an electrically insulating sheath 304 (both of which have been detailed in the FIG. 2A). The electrode 302 and insulating sheath 304 have an inclined top surface, where one edge is of height m₁ and an opposing edge is of height m₂ (where m₂ is greater than m₁). An electrically conducting interlayer 306 is disposed on the electrically insulating sheath 304. The inclined surface 412 contacts the battery foils when the electrode is in operation.

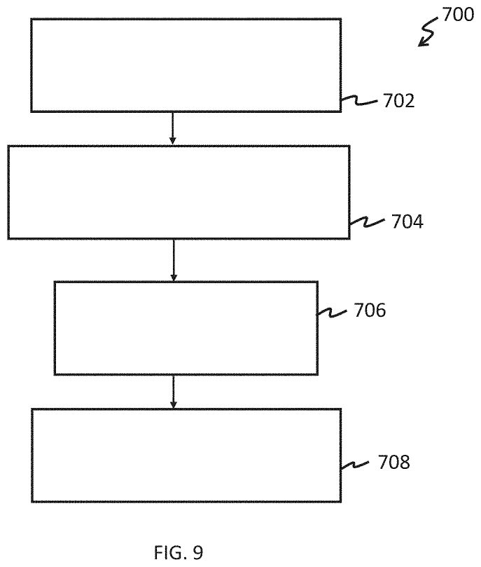

FIG. 9 is a flow diagram that depicts an exemplary method 700 of performing a spot weld. The method 700 comprises disposing a battery tab and a plurality of battery foils between two opposing electrodes 702. At least one of the electrodes is a non-stick electrode. An electrical current is discharged 704 between the two opposing electrodes. A portion of the battery foils is melted 706. The molten portion of the battery foils is then solidified 708 upon cooling thus bonding them together.

In one embodiment, in one method of manufacturing the non-stick electrode, an electrode that comprises a cylindrical piece of metal is first coated with an electrically insulating sheath over a portion of the electrode. The cylindrical piece of metal may be heated to up to 60° C. for 5 minutes. A space at the upper surface of the cylindrical piece of metal is left uncoated. An optional mask may be placed on the uncoated portion of the electrode and the electrode sprayed with an electrically insulating coating such as boron nitride. The optional mask may then be removed. An electrically conducting interlayer (e.g., such as a piece of graphene or graphite) is then disposed on the surface of the electrically insulating coating to form the non-stick electrode.

The opposing electrode may have a planar surface or a knurled surface as is desired. The knurls may be produced by milling or an electrical discharge machining. The opposing electrodes are now ready for use in a resistance spot welding operation.

In using the device, a battery foils and tab may be placed between the opposing electrodes. One or both electrodes may be non-stick electrodes. As seen in the figures, when one of the electrodes is a non-stick electrode, the opposing electrode may have a graphite interlayer placed between the foils/tab and the electrode (that is not a non-stick electrode).

The electrode that is not a non-stick electrode may have a planar surface or knurled surface. An electric current is discharged from a charging device (e.g., a battery or generator) via a transformer to the electrodes that are in contact with the battery foils (with or without tabs). The battery foils are heated upon being electrified by virtue of their electrical resistance. This resistive heating melts the foils to produce a puddle. The puddle upon cooling solidifies to produce bonding between the foils or alternatively, between the foils and the tab(s).

The electrodes may then be removed and moved to another spot on the battery where they are brought into contact with the foils and the process is repeated to produce another spot weld.

The non-stick electrode and the device that uses the electrode may be exemplified by the following non-limiting example.

### EXAMPLE

### Example 1

This example was conducted to demonstrate one method of manufacturing a non-sticking electrode. In this approach, boron nitride (BN) is sprayed directly onto a preheated electrode (a cylindrical piece of metallic copper) leaving a circular central region (4˜8 mm in diameter) untouched in order to not hinder the passage of an electrical current.

This approach relies on the Van der Waals forces to facilitate adhesion between the BN and the graphite interlayer. Once the BN is applied on the electrode surface at the preheating temperature, it is strongly adhesively bonded to the electrode surface. This method permits bonding of the graphite interlayer to the copper electrode via the boron nitride interface.

One disadvantage of this approach is that after preparing the electrode, only around 2˜3 welds can be performed before the electrode needs to be re-dressed with a new graphite foil. This is because graphite is brittle and the fracture of graphite foil can lead to uneven heat generation during welding process. Molten aluminum can then penetrate through cracks in the graphite foil and damage the electrode. Therefore, cleaning of the electrode coating on the top surface is desirable after each weld for reliable weld quality.

### Example 2

In this approach a graphite foil is replaced after each welding run. Specifically, the BN is sprayed directly onto the preheated graphite foil while leaving the center region (4˜8 mm in diameter) untouched so as to allow for current passage.

The BN is also sprayed on electrode except the top surface. The stacking order of electrode-BN-Graphite foil is the same as in Example 1, without producing a bond between the electrode and the BN layer.

In other words, the bond is only created between the graphite foil and BN whereas the bonding force between electrode and BN is negligible. Therefore, the BN covered graphite foil can be replaced easily after each weld to achieve reliable weld quality.

The non-stick electrode may be used for ultrasonic resistance spot welding or could be used for regular resistance spot welding as well to perform electrode sticking. This technology allows thin foil welding while avoiding the porosity associated with laser welding. The interlayer needs to be reapplied for each weld, or every few welds. This is a less expensive fix than replacing the electrode. Replacing the electrically conducting interlayer can be performed quickly and efficaciously when compared with replacing the electrode. The coating improves weld strength and decreases the instance of cracking during manufacture.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A non-stick electrode comprising:
an electrode;
an electrically insulating sheath disposed thereon; where the electrically insulating sheath has an opening on a surface of the electrode through which an electric current is transmitted or received to or from an opposing electrode; where the electrode protrudes through the opening in the electrically insulating sheath; and
an electrically conducting interlayer disposed on the electrode such that it contacts the electrode at the opening in the sheath; and wherein the electrically conducting interlayer comprises a material that decomposes at a temperature that is greater than a temperature of a metal that is liquified on contact with the non-stick electrode.

2. The non-stick electrode of claim 1, wherein the electrode comprises a metal; wherein the metal is copper, a copper-tungsten alloy, copper alloys, steel, brass, tungsten, chromium, zirconium, molybdenum, or a combination thereof.

3. The non-stick electrode of claim 1, wherein the electrically insulating sheath comprises a ceramic or an organic polymer.

4. The non-stick electrode of claim 3, wherein the ceramic comprises silica, quartz, alumina, titania, ceria, zirconia, boron nitride, or a combination thereof.

5. The non-stick electrode of claim 1, wherein the electrically conducting interlayer comprises graphene, graphite, carbon-nanotube paper; carbon nanotube-carbon black paper; or a combination thereof.

6. The non-stick electrode of claim 1, wherein the electrically conducting interlayer is replaceable.

7. The non-stick electrode of claim 1, wherein the electrically conducting interlayer prevents adhesion of the electrode to a battery foil or to a battery tab during a welding operation.

8. The non-stick electrode of claim 1, wherein the electrically insulating sheath has a thickness of 50 to 300 micrometers.

9. The non-stick electrode of claim 1, wherein the opening on the surface of the electrode has a diameter of 2 to 10 millimeters.

10. The non-stick electrode of claim 1, wherein the electrically conducting interlayer has a thickness of 0.1 to 0.5 millimeters.

11. The non-stick electrode of claim 1, wherein the electrically conducting interlayer is reversibly bonded to the electrically insulating sheath with boron nitride.

12. A spot welding device that comprises the non-stick electrode of claim 1.

13. The spot welding device of claim 12, further comprising an opposing electrode that lies opposite to the non-stick electrode; wherein the opposing electrode is also a non-stick electrode that comprises the electrically conducting interlayer.

14. The spot welding device of claim 12, further comprising an opposing electrode that lies opposite to the non-stick electrode; wherein the opposing electrode is not a non-stick electrode.

15. The spot welding device of claim 14, wherein the opposing electrode contacts a graphite foil and wherein an opposite side of the graphite foil contacts a battery foil or tab.

16. A method of manufacturing a non-stick electrode comprising:
disposing an electrically insulating sheath on an electrode; where the electrically insulating sheath has an opening on a surface of the electrode through which an electric current is transmitted or received to or from an opposing electrode; where the electrode protrudes through the opening in the electrically insulating sheath; and
disposing an electrically conducting interlayer on the electrode such that it contacts the electrode at the opening in the insulating sheath; and wherein the electrically conducting interlayer comprises a material that decomposes at a temperature that is greater than a temperature of a metal that is liquified on contact with the non-stick electrode.

17. The method of claim 16, wherein the electrically conducting interlayer contacts the electrically insulating sheath.

18. A method of performing a spot weld comprising:
disposing a battery tab and a plurality of battery foils between two opposing electrodes; wherein at least one of the electrodes is a non-stick electrode; wherein the non-stick electrode comprises:
an electrode;
an electrically insulating sheath disposed thereon; where the electrically insulating sheath has an opening on a surface of the electrode through which current is transmitted or received to or from an opposing electrode; and
an electrically conducting interlayer disposed on the electrode such that contacts the electrode at the opening in the electrically insulating sheath; and wherein the electrically conducting interlayer comprises a material that decomposes at a temperature that is greater than a temperature of a metal that is liquified on contact with the non-stick electrode; and
discharging an electrical current between the two opposing electrodes;
melting a portion of the battery foils; and
solidifying the molten portion of the battery foils thus bonding them together.

19. The method of claim 18, wherein the battery tab is bonded to the battery foils when the molten portion of the battery foils undergoes solidification.

20. The method of claim 18, wherein the electrical current is discharged to the non-stick electrode from the opposing electrode.
